(19) United States
(12) Patent Application Publication
(10) Pub. No.: US 2005/0244565 A1
(43) Pub. Date: Nov. 3, 2005

(54) Edible emulsion with reduced fat and cholesterol

(75) Inventors: Monika Maria Tobolewska, Tenafly, NJ (US); Thomas Vincent Merolla, Hillsborough, NJ (US); Sergey Michailovich Melnikov, Spijkenisse (NL); Donald Joseph Hamm, New Providence, NJ (US); Frederik Michiel Meeuse, Den Haag (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 10/835,019

(22) Filed: Apr. 29, 2004

(51) Int. Cl. A23L 1/238

(52) U.S. Cl. 426/605

(57) ABSTRACT

An edible emulsion with a viscosity of 4,500 cps or higher is described. The edible emulsion has 75.0% by weight oil, or less, and less than 4.0% by weight liquid emulsifier. The edible emulsion has good color, texture and flavor characteristics and is substantially free of cholesterol and carbohydrates.

### FIELD OF THE INVENTION

The present invention is directed to an edible emulsion having reduced levels of oil and cholesterol. More particularly, the present invention is directed to an edible emulsion comprising 75.0% by weight oil, or less, and typically less than 4.0% by weight of liquid emulsifier. The edible emulsion of the present invention, unexpectedly, is excellent tasting, able to maintain a viscosity of at least about 4,500 cps in the absence of starch, and substantially free of cholesterol and carbohydrates.

### BACKGROUND OF THE INVENTION

Obesity is a concern for men, women and children in many nations. There is a trend, therefore, for food manufactures to formulate products with reduced levels of fat in order to minimize caloric intake. Reduced fat products, unfortunately, tend to have characteristics (e.g., flavor and texture characteristics) that are inferior to those of full-fat and calorie products. For example, mayonnaise compositions (which traditionally have about 80.0% by weight oil) have been formulated with reduced levels of oil. When the oil content of the composition is less than 65.0% by weight, the mayonnaise composition cannot be classified as real (the standard of identity for real mayonnaise requires at least 65.0% by weight oil) and starch and/or other thickeners are usually required to obtain a consumer acceptable viscosity.

When the oil levels are reduced within a real mayonnaise range (e.g., 65.0% to 75.0% by weight), emulsifier, like egg yolk, is typically required at a level which is at least (in liquid form) 4.0% by weight of the total weight of the mayonnaise composition so that a product with a consumer acceptable viscosity can be obtained and maintained over the shelf-life of the product. High levels of egg yolk, however, typically result in a mayonnaise composition that is high in cholesterol.

There is increasing interest to develop an edible emulsion that has reduced levels of oil and cholesterol, but which also has the characteristics of a full-fat emulsion. This invention, therefore, is directed to an edible emulsion comprising 75.0% by weight oil, or less, and less than 4.0% by weight liquid emulsifier. The edible emulsion of this invention is, unexpectedly, excellent tasting, able to maintain a viscosity of at least about 4,500 cps in the absence of starch, and substantially free of cholesterol and carbohydrate.

Additional Information

Efforts have been disclosed for making edible emulsions. In U.S. Pat. No. 4,923,707, mayonnaise compositions with corn syrup having a low D.E. are described.

Other efforts have been disclosed for making edible emulsions. In International Application No. WO 02/39833, described are mayonnaise compositions with levels of liquid egg yolk at 4.0% by weight, or more, and dry matter content of emulsifier at 2.0% by weight, or more.

Still other efforts have been disclosed for making edible emulsions. In U.S. application No. 2002/0127324, a process for making emulsified spoonable and pourable dressings is described.

None of the additional information above describes an edible emulsion having reduced levels of oil and cholesterol, and particularly, 75.0% by weight oil, or less, and less than 4.0% by weight of liquid emulsifier whereby the edible emulsion is able to maintain a viscosity of at least about 4,500 cps.

### SUMMARY OF THE INVENTION

In a first aspect, the present invention is directed to an edible emulsion comprising 75.0% by weight oil, or less, and less than 4.0% by weight liquid emulsifier wherein the edible emulsion has a viscosity of at least about 4,500 cps.

In a second aspect, the present invention is directed to an edible emulsion comprising 75.0% by weight oil, or less, and less than 2.0% by weight dry matter content of emulsifier wherein the edible emulsion has a viscosity of at least about 4,500 cps.

In a third aspect, the present invention is directed to a method for making the edible emulsions described in the first two aspects of this invention.

Emulsion, as used herein, means a suspension or dispersion of one liquid within a second immiscible liquid and is preferably an oil-in-water or water-in-oil-in-water emulsion, and most preferably, an oil-in-water emulsion. Substantially free of cholesterol means less than about 6.0 mg of cholesterol in a 15.0 ml serving. Substantially free of carbohydrates means less than about 1.0 g of carbohydrate per 15.0 ml serving. Oil, as used herein, means triglycerides, and especially, those that are liquids at ambient temperature. Emulsifier, as used herein, means an agent suitable to promote the formation of an emulsion, and not egg white. Full-fat, as used herein, means over 75.0% by weight oil, based on total weight of the edible emulsion. Viscosity, as used herein, means rheological properties of a product taken on a Haake Rheometer (Rotovisco RV20) at room temperature using a set of concentric cylinders (or bob-in-cup) with a 1 mm gap, the bob having a diameter of 1.0 cm and length of 1.0 cm. The inner cylinder or bob starts rotating from zero shear rate and ramps up to a shear rate of 134 sec⁻¹ in 542 sec. By way of comparison, the viscosity values refer to the shear rate of 10 sec⁻¹. Has or is able to maintain a viscosity of at least about 4,500 cps means has a viscosity of at least about 4,500 cps for at least about three weeks after being stored at ambient temperature

### DETAILED DESCRIPTION OF THE PREFERRED EMBODIMENTS

The only limitation with respect to the type of oil used to make the edible emulsion of this invention is that the oil is suitable for human consumption. Illustrative examples of the types of oil which may be used in this invention include, without limitation, those which are liquid at ambient temperature like avocado, mustard, coconut, cottonseed, fish, flaxseed, grape, olive, palm, peanut, rapeseed, safflower, sesame, soybean, sunflower, mixtures thereof or the like.

Other types of oils which may be used in this invention are solid at ambient temperature. Illustrative examples of the oils which are solid at room temperature and suitable for use in this invention include, without limitation, butter fat, chocolate fat, chicken fat, coconut oil, hydrogenated palm kernel oil, mixtures thereof or the like.

In a preferred embodiment, the oil used in this invention is a liquid at ambient temperature. In a most preferred embodiment, the oil used in this invention is soybean, sunflower or rapeseed oil or a mixture thereof.

The amount of oil used in the edible emulsion of this invention is typically at least about 65.0% by weight to 75.0% by weight, based on total weight of the edible emulsion and including all ranges subsumed therein. Preferably, the amount of oil employed in the edible emulsion is from about 65.0% to about 74.0%, and most preferably, from about 65.0% to about 72.5% by weight, based on total weight of the edible emulsion and including all ranges subsumed therein.

The water used in this invention can be pure water, tap water, bottled water, deionized water, spring water, or a mixture thereof. Thus, the water used in this invention may be an aqueous solution comprising salts or minerals or both. Typically, water makes up the balance of the edible emulsion with reduced fat and cholesterol.

The emulsifier suitable for use in this invention often has an HLB of greater than about 8.0, and preferably, greater than about 11.0, and most preferably, from about 12.0 to about 18.0, including all ranges subsumed therein. Illustrative examples of the types of emulsifier suitable for use in this invention include protein, like fruit, vegetable, milk (e.g., whey) or soy protein and other natural and synthetic food emulsifiers, or mixtures thereof.

Other emulsifiers suitable for use in this invention include phospholipid, whole egg (egg white not being emulsifier), egg yolk or a mixture thereof. In a preferred embodiment, the emulsifier comprises egg yolk having been modified with enzymes or by fermentation. In an especially preferred embodiment, the emulsifier is egg yolk or egg yolk in whole egg whereby the same has been modified with phospholipase A2 to convert egg yolk lecithin to lysolecithin. Illustrative examples of the types of enzymes which can be used to convert the egg yolk lecithin to lysolecithin are Lecitase, and Lysomax, made commercially available by Novo Nordisk and Genencor, respectively. An additional description of modified eggs suitable for use in this invention may be found in U.S. Pat. No. 5,028,447, the disclosure of which is incorporated herein by reference.

In a preferred embodiment, the emulsifier used in this invention is a liquid egg blend comprising enzyme modified egg yolk, egg white and salt wherein the same typically makes up from about 3.5% to about 5.0% by weight of the edible emulsion, including all ranges subsumed therein. In another preferred embodiment, the emulsifier of the present invention is from about 2.0% to about 3.75% by weight liquid egg yolk, and most preferably from about 2.75% to about 3.40% by weight liquid egg yolk, based on total weight of the edible emulsion, and including all ranges subsumed therein. In yet another preferred embodiment, the emulsifier employed in the present invention comprises, in dry form, from about 1.25% to less than 2.00% by weight dry egg yolk (i.e., dry matter content of emulsifier), and most preferably, from about 1.35% to about 1.65% by weight dry egg yolk, based on total weight of the edible emulsion and including all ranges subsumed therein.

Optional additives suitable for use in this invention include acidulants like acetic acid, citric acid, hydrochloric acid, lactic acid, malic acid, phosphoric acid, glucono-delta-lactone, mixtures thereof or the like. Typically enough acidulant is added to the edible emulsion of this invention to produce an emulsion having a pH from about 2.5 to about 4.5, and preferably, a pH from about 2.8 to about 3.8. In a preferred embodiment, the acidulant employed is vinegar and/or lemon juice, which typically and collectively makes up from about 2.0% to about 3.5% by weight of the total weight of the edible emulsion.

Additional optional additives suitable for use in this invention include salt (and other spices and seasoning) vitamins, natural and artificial flavors (e.g., mustard flavor) and colors, preservatives, antioxidants, chelators like EDTA, meat like ham and bacon bits or particulates, buffering agents, protein sources, vegetable bits or particulates, fruit bits or particulates, cheese, mixtures thereof or the like. These additional optional additives, when employed, typically and collectively make up less than about 20.0% by weight of the total weight of the edible emulsion.

Still other optional additives suitable for use in this invention include sweeteners like fructose, lactose, glucose, saccharose, syrups, dextrose, lactose, levelose, maltose, saccharin, aspartame, sucralose, mixtures thereof or the like. The amount of sweetener is such that the resulting edible emulsion has less than about 1.0 g of carbohydrate in a 15.0 ml serving to no carbohydrate in a 15.0 ml serving.

When making the edible emulsion of the present invention, ingredients (e.g., acidulant, soybean oil, water, liquid egg blend, spices, chelator) are typically added to a mixing tank in no particular order and mixed to produce a premix. Usually, the premix is made at ambient temperature, atmosphere pressure, and under moderate shear. Preferably, some acidulant is mixed with flavor, spices and emulsifier to produce an emulsifier mixture to be added to the mixing tank. The premix is preferably then fed through an emulsifying mixer like a colloid mill, homogenizer (e.g., like those equipped with transversally arranged plates with bores of about 0.5 to 3.5 mm), or preferably, an in-line mixer/emulsifier having a means to vary the gap opening between its stator and rotor and a variable speed motor (such as the one described in U.S. application No. 2002/0127324 A1, the disclosure which is incorporated herein by reference). The resulting edible emulsion which exits the emulsifying mixer employed has oil droplets (at least about 85.0% of all oil droplets) having a diameter from about 2.5 microns to about 10.0 microns. In preferred embodiment, at least about 90.0% of all oil droplets present within the resulting edible emulsion have a diameter from about 3.0 to about 5.5 microns. In yet another preferred embodiment, an inert gas, like nitrogen, can be used to modify product texture and appearance.

Surprisingly, the viscosity of the edible emulsion of the present invention has (i.e., maintains) a viscosity of at least about 4,500 cps, and preferably, from about 6,000 cps to about 50,000 cps, and most preferably, from about 10,000 cps to about 35,000 cps (including all ranges subsumed therein) when no starch or thickeners, like gums and the like, are employed and less than 4.0% by weight liquid emulsifier (having, when dry, preferably about 1.25% to less than 2.0% by weight dry egg yolk) is used.

Also, it is within the scope of this invention for the edible emulsion to be a real mayonnaise composition that has the taste and viscosity of conventional real mayonnaise, notwithstanding the fact that the real mayonnaise of this invention has less fat and cholesterol when compared to conventional products.

It is further noted herein, that even though 75.0%, or less, oil is employed in the edible emulsion of this invention, and only about 1.25% to less than 2.0% by weight dry egg yolk may be used as emulsifier, the edible emulsion of this invention has a consumer acceptable viscosity and is not over-sheared to a point where the desired emulsion's stability is jeopardized.

The packaging for the edible emulsion of this invention is often a glass or plastic jar, food grade sachet or squeezable plastic bottle. Sachets are preferred for food service applications, and a plastic bottle is preferred for domestic use.

The examples which follow are provided to facilitate an understanding of the present invention. The examples are not intended to limit the scope of the claims.

### EXAMPLE 1

Edible emulsions (mayonnaise compositions) having the following ingredients were made.

| Ingredient | Percent by Weight |
|---|---|
| Soybean Oil | 69.0-72.0 |
| Modified liquid egg blend | 4.3-4.7 |
| Lemon juice | 0.11-0.27 |
| Vinegar | 2.0-2.5 |
| Salt | 1.0-1.5 |
| Sugar | 2.0-2.5 |
| Flavor | 0.0075-0.0135 |
| Water | Balance |

Emulsifier mixtures were made by combining, in no particular order, modified liquid egg blend, salt, sugar, lemon juice (about 50.0% of the total) and flavor. The emulsifier mixture was fed to a premix tank along with an acid phase having vinegar, the remaining lemon juice and the balance of the ingredients. The ingredients were mixed for about 2.0 minutes at ambient temperature and under moderate shear to produce pre-emulsions. The pre-emulsions were fed to an in-line mixer/emulsifier (e.g., Ross Mill) with gaps, of low rates and mill speed adjusted to yield an edible emulsion having at least 85.0% of its oil droplets with a diameter from about 2.5 microns to about 10.0 microns. The resulting edible emulsions were placed in 12 oz. glass jars and left at room temperature. The viscosities of the edible emulsions were about 29,000 cps after being checked at one, three and five week intervals.

### EXAMPLE 2

Approximately 20 panelists tasted and visually assessed the edible emulsions of Example 1, comparing the same to Kraft's real mayonnaise and conventional Hellmann's real mayonnaise. The panelists unanimously concluded that the edible emulsions of this invention had the same texture as Kraft's real mayonnaise and Hellman's real mayonnaise. Unexpectedly, the panel also concluded that the edible emulsions of this invention (having less fat and cholesterol) had an acceptable mayonnaise taste, even with reduced fat and cholesterol.

1. An edible emulsion comprising 75.00% by weight oil, or less, and emulsifier, wherein the emulsifier, when dried, comprises from about 1.250% to less than 2.0% by weight dry matter content as emulsifier, the edible emulsion having a viscosity of at least about 4,500 cps.

2. The edible emulsion according to claim 1 wherein the emulsifier is liquid egg yolk, or liquid whole egg, and the edible emulsion comprises less than about 4.0% by weight liquid emulsifier.

3. The edible emulsion according to claim 2 wherein the egg yolk and egg yolk within the liquid whole egg is enzyme modified.

4. The edible emulsion according to claim 3 the enzyme modified egg yolk comprises lecithin that has been converted to lysolecithin.

5. The edible emulsion according to claim 1 wherein the viscosity of the edible emulsion is 6,000 cps to 50,000 cps.

6. The edible emulsion according to claim 1 wherein the edible emulsion comprises form about 3.5% to about 5.0% by weight liquid egg blend.

7. The edible emulsion according to claim 1 wherein the edible emulsion comprises from about 65.0% to about 74.0% by weight oil.

8. The edible emulsion according to claim 1 wherein the edible emulsion has a pH from about 2.5 to about 4.5.

9. The edible emulsion according to claim 1 wherein the edible emulsion has less than about 1.0 g carbohydrate per 15.0 ml serving.

10. The edible emulsion according to claim 1 wherein the edible emulsion comprises less than about 6.0 mg of cholesterol in about a 15.0 ml serving.

11. The edible emulsion according to claim 1 wherein the oil is present as droplets having a diameter from about 2.5 microns to about 10.0 microns.

12. The edible emulsion according to claim 11 wherein the droplets have a diameter from about 3.0 to about 5.5 microns.

13. The edible emulsion according to claim 1 wherein the oil is soybean oil, sunflower oil, or a mixture thereof.

14. The edible emulsion according to claim 1 wherein the edible emulsion is real mayonnaise.

15. The edible emulsion according to claim 1 wherein the viscosity of the edible emulsion is 10,000 cps to 35,000 cps.

16. A method for making an edible emulsion comprising, in no particular order, the steps of:
(a) combining oil, water and emulsifier to produce a premix; and
(b) subjecting the premix to an emulsifying mixer
wherein the edible emulsion comprises 75.0% by weight oil or less, has a viscosity of at least about 4,500 cps and further wherein the emulsifier, when dry, comprises from about 1.25% to less than about 2.0% by weight dry matter content of emulsifier.

17. The method according to claim 16 wherein the edible emulsion is real mayonnaise.
